(19) United States
(12) Patent Application Publication
(10) Pub. No.: US 2009/0248943 A1
(43) Pub. Date: Oct. 1, 2009

(54) SERVER

(75) Inventors: Ming-Ci Jiang, Shanghai City (CN); Chih-Feng Chen, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 12/116,406

(22) Filed: May 7, 2008

(30) Foreign Application Priority Data
Apr. 1, 2008 (TW) 97111847

(51) Int. Cl. G06F 13/20

(52) U.S. Cl. 710/313

(57) ABSTRACT

A server includes a mother board, a back board and a bridge board. A plurality of first connection lines and a first slot are disposed on the mother board. The first connection lines are employed for delivering a plurality of power signals and a plurality of control signals. A second slot is disposed on the back board. The bridge board has a first golden finger and a second golden finger, and a plurality of second connection lines are disposed on the bridge board and is electrically connected to the first golden finger and the second golden finger. The first golden finger and the second golden finger are respectively inserted into the first slot and the second slot. In this way, the control signals and the power signals from the mother board are delivered to the back board through the second connection lines on the bridge board.

### CROSS-REFERENCE TO RELATED APPLICATION

This application claims the priority benefit of Taiwan application serial no. 97111847, filed on Apr. 1, 2008. The entirety of the above-mentioned patent application is hereby incorporated by reference herein and made a part of this specification.

### BACKGROUND OF THE INVENTION

1. Field of the Invention

The present invention generally relates to a server, and more particularly, to a server suitable for reducing deployment of transmission lines.

2. Description of Related Art

Servers are broadly used by various enterprises today, and the server incorporating the applications in Internet and communication industry has got significant development and is also penetrated into our daily lives, such as money market, financial business, Internet bank and Internet credit card transaction, where by means of the powerful computing capacity of the server, the data can be highly encrypted to prevent decoding. A server functions, as the term thereof indicates, that providing numerous processed information in LAN (local area network), Internet or other networks, delivering the information to the terminals of the server through a network and being output to any user needing the above-mentioned information.

FIG. 1 is a system architecture diagram of a conventional server. Referring to FIG. 1, a conventional server 100 includes a mother board 110, a front board 120, a back board 130, a plurality of fans 141-144, a system chip 150 and a plurality of connectors 161-165, wherein the connectors 161-165 are, for example, power control connector, SATA (serial advanced technology attachment) connector, IDE (integrated development environment) connector, floppy disk drive connector and USB connector. the connectors 161-165 are respectively electrically connected to the front board 120 and the back board 130 through transmission lines 172-175. In this way, the mother board 110 is able to control hardware devices on the front board 120 and the back board 130. On the other hand, the system chip 150 is used to generate signals delivered by the connectors 161-165; the fans 141-144 are used to dissipate the waste heat produced by the conventional server 100.

Since the conventional server 100 requires a large number of transmission lines 172-175 to electrically connect the connectors 161-165 to the front board 120 and the back board 130; therefore, many transmission lines are distributed in the hardware space of the conventional server 100, which makes the interior space of the system appear not good with neat and nice look. Moreover, a large number of transmission lines 172-175 not only reduces the heat-dissipating mechanism of the conventional server 100, but also reduces the system stability thereof.

### SUMMARY OF THE INVENTION

Accordingly, the present invention is directed to a server to reduce obstructing the heat-dissipating mechanism of a system caused by transmission lines.

The present invention is also directed to a server suitable to make the hardware space of the server appear better with neat and nice look.

The present invention provides a server, which includes a mother board, a back board and a bridge board. A plurality of first connection lines and a first slot are disposed on the mother board, wherein the first connection lines are electrically connected to the first slot for delivering a plurality of power signals and a plurality of control signals. In addition, the control signals respectively conform one of a plurality of data transfer interfaces.

A second slot is disposed on the back board. The bridge board has a first golden finger and a second golden finger, and a plurality of second connection lines is disposed on the bridge board to electrically connect the first golden finger to the second golden finger. The first golden finger and the second golden finger herein are respectively inserted into the first slot and the second slot, so that the control signals and the power signals both from the mother board are delivered to the back board through the second connection lines.

In an embodiment of the present invention, the above-mentioned data transfer interfaces includes a universal serial bus interface, a SATA interface, a floppy disk drive interface and an integrated drive electronics interface.

In an embodiment of the present invention, the server further includes a system chip and a plurality of expansion slots, wherein the system chip and the expansion slots are disposed on the mother board. Besides, the system chip is used to generate a part of the control signals from the mother board; the expansion slots are used to accept a plurality of expansion cards to be inserted therein, and the expansion cards generate a part of the control signals from the mother board as well.

The present invention also provides a server, which includes a front board, a back board, a mother board, a first bridge board and a second bridge board. The front board and the back board respectively have a first slot and a second slot. A plurality of first connection lines, a plurality of second connection lines, a third slot and a fourth slot are disposed on the mother board.

The first connection lines herein are electrically connected to the third slot for delivering a plurality of power signals and a plurality of first control signals conforming to the specification of a specific data transfer interface. In addition, the second connection lines are electrically connected to the fourth slot for delivering a plurality of second control signals conforming the specifications of a plurality of data transfer interfaces

The first bridge board has a first golden finger and a second golden finger, and a plurality of third connection lines is disposed on the first bridge board to electrically connect the first golden finger to the second golden finger. The first golden finger and the second golden finger herein are respectively inserted into the first slot and the third slot, so that the first control signals and the power signals both from the mother board are delivered to the front board through the third connection lines.

The second bridge board has a third golden finger and a fourth golden finger, and a plurality of fourth connection lines is disposed on the second bridge board to electrically connect the third golden finger to the fourth golden finger. The third golden finger and the fourth golden finger herein are respectively inserted into the second slot and the fourth slot, so that the second control signals from the mother board are delivered to the back board through the fourth connection lines.

Since the present invention uses the connection lines on the bridge board to substitute the transmission lines between the mother board and the front board or the back board. In this way, the server provided by the present invention is able to reduce obstructing the heat-dissipating mechanism of the system caused by the transmission lines and thereby to promote the stability of the internal system. Moreover, the hardware space of the server appears better with neat and nice look due to fewer transmission lines are disposed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system architecture diagram of a conventional server.

FIG. 2 is a system architecture diagram of a server according to the first embodiment of the present invention.

FIG. 3 is a cross-section diagram of the server 200 of FIG. 2 along a transverse direction A2.

FIG. 4A is a cross-section diagram of a server 200 provided by an embodiment of the present invention along a longitudinal direction B2 (shown by FIG. 2).

FIG. 4B is a cross-section diagram of a server 200 provided by another embodiment of the present invention along a longitudinal direction B2 (shown by FIG. 2).

FIG. 5 is a system architecture diagram of a server according to the second embodiment of the present invention.

FIG. 6A is a cross-section diagram of a server 500 provided by an embodiment of the present invention along a longitudinal direction B5 (shown by FIG. 5).

FIG. 6B is a cross-section diagram of a server 500 provided by another embodiment of the present invention along a longitudinal direction B5 (shown by FIG. 5).

FIG. 7 is a system architecture diagram of a server according to the third embodiment of the present invention.

FIG. 8A is a cross-section diagram of a server 700 provided by an embodiment of the present invention along a longitudinal direction B5 (shown by FIG. 7).

FIG. 8B is a cross-section diagram of a server 700 provided by another embodiment of the present invention along a longitudinal direction B5 (shown by FIG. 7).

FIG. 9A is a cross-section diagram of a server 700 provided by an embodiment of the present invention along a longitudinal direction B5 (shown by FIG. 7).

FIG. 9B is a cross-section diagram of a server 700 provided by another embodiment of the present invention along a longitudinal direction B5 (shown by FIG. 7).

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

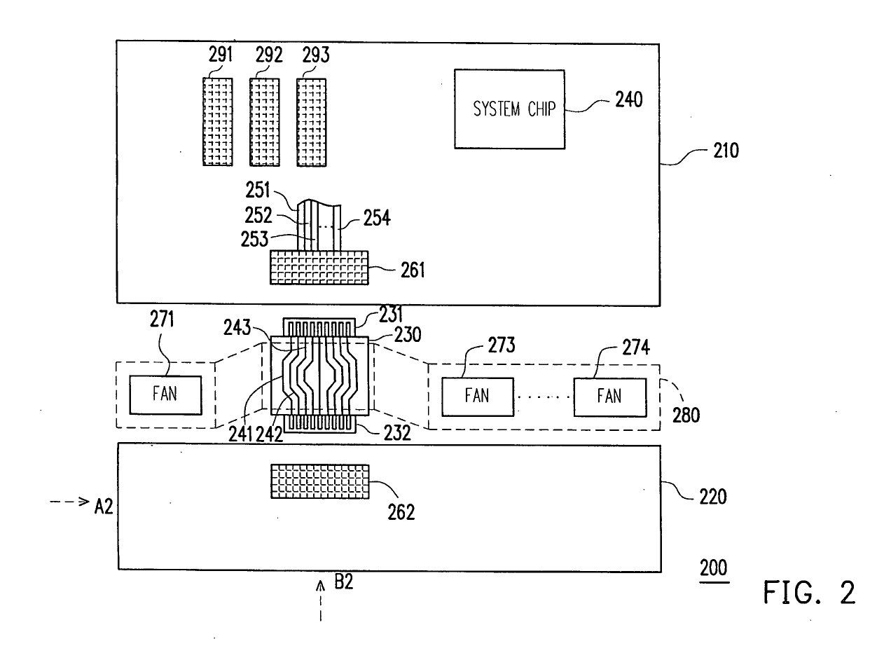

FIG. 2 is a system architecture diagram of a server according to the first embodiment of the present invention. Referring to FIG. 2, a server 200 includes a mother board 210, a back board 220 and a bridge board 230, wherein a plurality of connection lines 251-254 and a slot 261 are disposed on the motherboard 210. The connection lines 251-254 are electrically connected to the slot 261 for delivering a plurality of power signals and a plurality of control signals, wherein the above-mentioned control signals respectively conform one of the specifications of a plurality of data transfer interfaces. Another slot 262 is disposed on the back board 220.

The bridge board 230 further has two golden fingers 231 and 232. In addition, a plurality of connection lines, for example, connection lines 241-243 shown in FIG. 2, is disposed on the bridge board 230 and electrically connected to the golden fingers 231 and 232. In terms of the overall architecture, the golden fingers 231 and 232 can be respectively inserted into the slots 261 and 262, and thereby, the control signals and power signals from the mother board 210 are delivered to the back board 220 through the connection lines disposed on the bridge board 230.

Note that the data transfer interfaces which the control signals from the mother board 210 must conform include a USB interface (universal serial bus interface), an SATA interface, a floppy disk drive interface and an IDE interface (integrated drive electronics interface).

Besides, in the present embodiment, the slots 261 and 262 can be implemented by using slots conforming to the PCI-X interface specification or the PCI-E interface specification. For example, corresponding to the back board 220 adopting parallel data-transferring mode, a slot conforming to the PCI-X interface specification is directly used; in contrast, corresponding to the back board 220 adopting serial data-transferring mode, a slot conforming to the PCI-E interface specification is directly used, and the above-mentioned configurations are well known for anyone skilled in the art. Furthermore, a serial-to-parallel converter or a parallel-to-serial converter can be respectively disposed on the mother board 210 and the back board 220 to optionally use the slot conforming to the PCI-X interface specification or the slot conforming to the PCI-E interface specification.

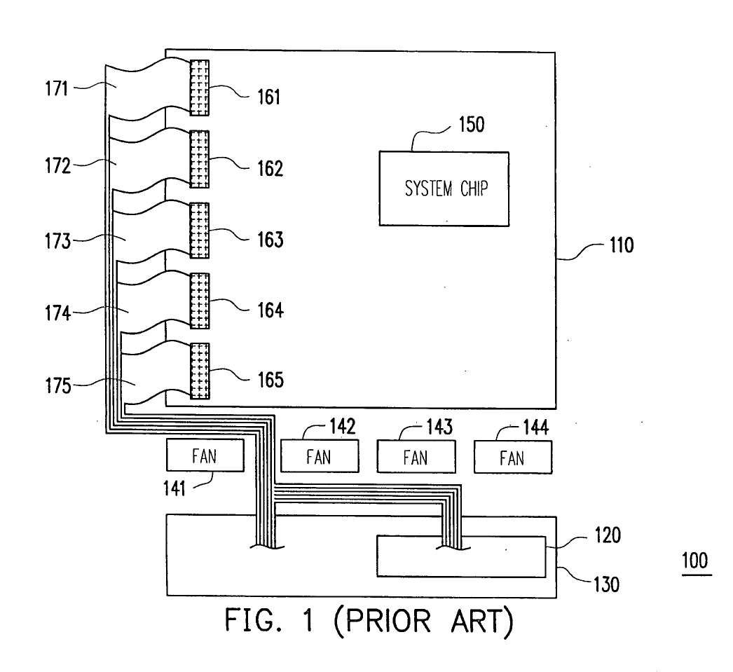

Particularly, compared to the prior art, the embodiment is able to use the connection lines disposed on the bridge board 230 to deliver signals to the front board and the back board; while the conventional server 100 (as shown in FIG. 1) would conduct the same job by employing a large number of transmission lines. In this way, the server 200 of the present invention can reduce obstructing the heat-dissipating mechanism of a system caused by the transmission lines and thereby promote the stability of the internal system. Along with less transmission lines disposed, the hardware space of the server 200 would accordingly appear better with neat and nice look.

Moreover, the server 200 further includes a system chip 240, a plurality of fans 271-274, a frame 280 and a plurality of expansion slots 291-293, wherein the system chip 240 is disposed on the mother board 210 for generating a part of the control signal delivered by the connection lines 251-254.

The expansion slots 291-293 are disposed on the mother board 210 for accepting a plurality of expansion cards to be inserted therein. The expansion cards inserted in the expansion slots 291-293 are able to generate a part of the control signals delivered by the connection lines 251-254 as well. In the embodiment, the expansion card includes a SATA expansion card, a SCSI expansion card and a SAS expansion card (serial attached SCSI expansion card). The expansion slots 291-293 conform to the specification of PCI interface or PCI-E interface.

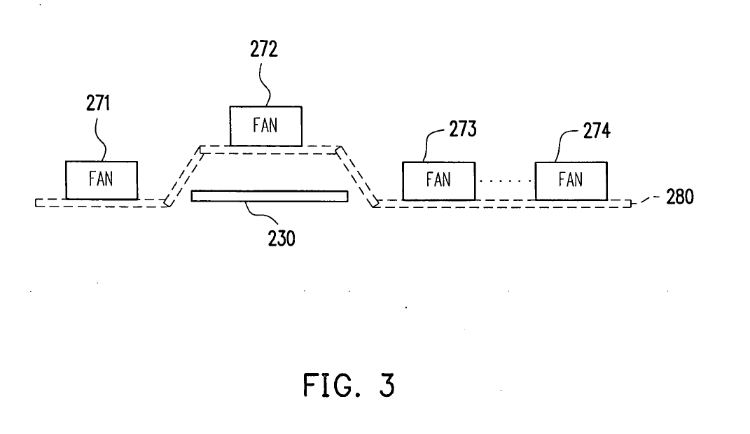

FIG. 3 is a cross-section diagram of the server 200 of FIG. 2 along a transverse direction A2. Referring to FIGS. 2 and 3, a frame 280 is parallel to the bridge board 230. The lower surface of the frame 280 is across the bridge board 230 and fans 271-274 are disposed on the upper surface thereof. The fans 271-274 are used to produce an airflow for reducing the waste heat of the server 200. Although the bridge board 230 occupies a portion of the hardware space of the server 200, but the frame 280 is across the bridge board 230 looking like a bridge and a fan 272 correspond to the bridge board 230 disposed over the bridge board 230; therefore, the heat-dissipating mechanism of the server 200 is not effected by the bridge board 230.

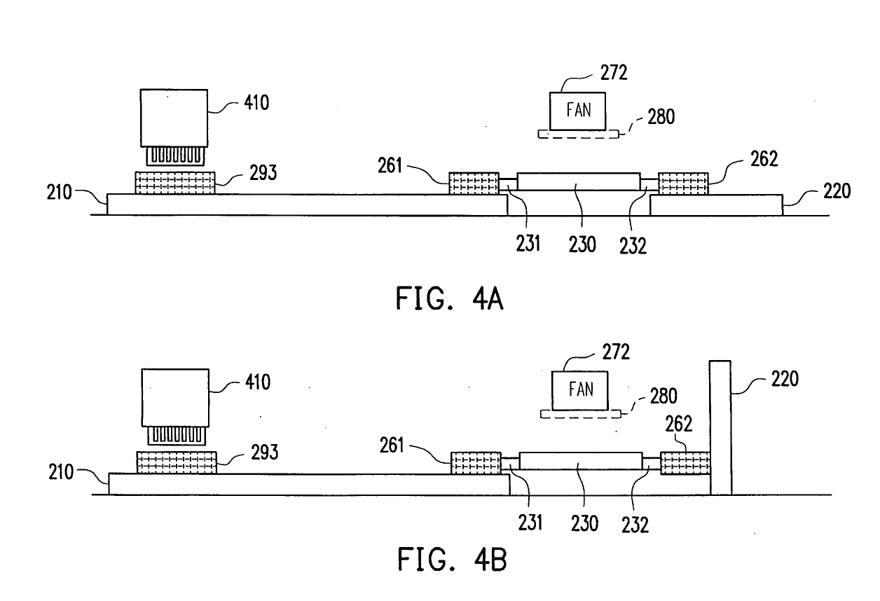

The real related positions of the backboard 220, the mother board 210 and the bridge board 230 are shown in FIGS. 4A and 4B, wherein FIG. 4A is a cross-section diagram of a server 200 provided by an embodiment of the present invention along a longitudinal direction B2 (shown by FIG. 2) and FIG. 4B is a cross-section diagram of a server 200 provided by another embodiment of the present invention along a longitudinal direction B2 (shown by FIG. 2).

Referring to FIGS. 2 and 4A, the back board 220, the mother board 210 and the bridge board 230 can be parallel to each other. As shown in FIG. 4A for example, the mother board 210 is parallel to a direction in a side surface of the bridge board 230, and the golden finger 231 is disposed on the side surface of the bridge board 230. Similarly, the back board 220 is parallel to another direction in another side surface of the bridge board 230, and the golden finger 232 is disposed on the other side surface of the bridge board 230. Furthermore as shown in FIG. 4A, the frame 280 is across the bridge board 230 and a fan 272 corresponds to the bridge board 230 disposed over the bridge board 230. Note that an expansion card 410 is also shown in FIG. 4A, and the expansion card 410 would be inserted into the expansion slot 293.

Continuing to FIGS. 4A and 4B, although the two embodiments shown by FIGS. 4A and 4B are the same that the mother board 210 is parallel to a direction in a side surface of the bridge board 230, and the golden finger 231 is disposed on the side surface of the bridge board 230, but there is an significant difference between the two embodiments. Different from the embodiment of FIG. 4A, in the embodiment of FIG. 4B, the back board 220 is perpendicular to another direction in another side surface of the bridge board 230, and the golden finger 232 is accordingly disposed on the other side surface of the bridge board 230. The other structure details of the embodiment of FIG. 4B are the same as the embodiment of FIG. 4A, and the details are omitted for simplicity.

### The Second Embodiment

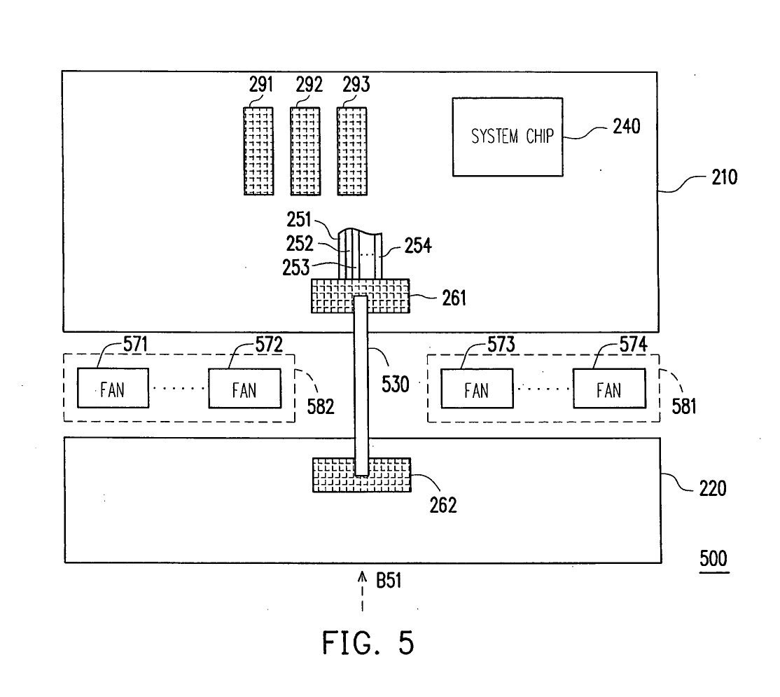

FIG. 5 is a system architecture diagram of a server according to the second embodiment of the present invention. Referring to FIG. 5, the main difference of the second embodiment from the first embodiment rests in the layout relationship in the server 500 between the bridge board 530, the fans 571-574 and the frames 581 and 582.

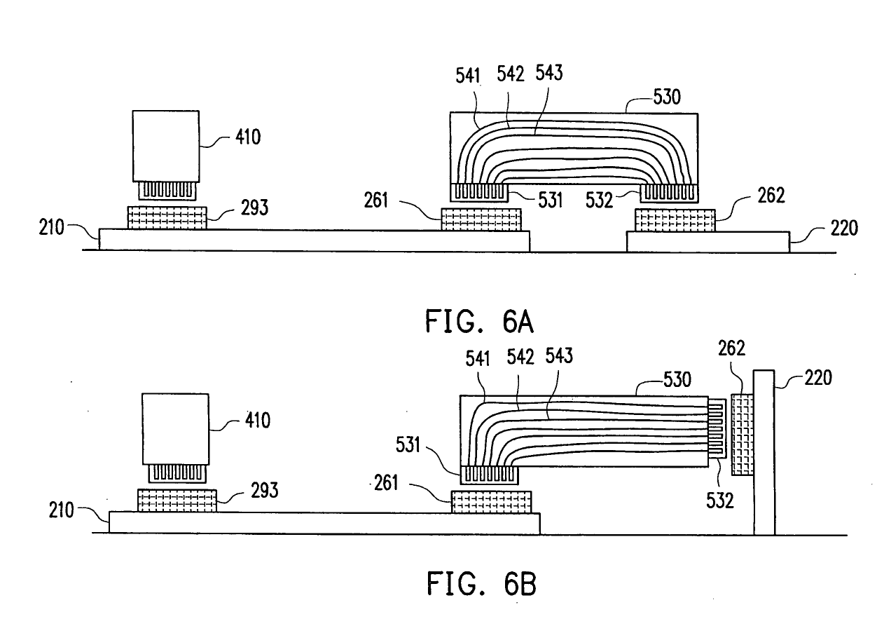

In more detail, in the second embodiment, the back board 220, the mother board 210 and the bridge board 530 and the disposition relationship between them are as shown in FIGS. 6A and 6B, wherein FIG. 6A is a cross-sectional diagram of a server 500 provided by an embodiment of the present invention along a longitudinal direction B5 (shown by FIG. 5) and FIG. 6B is a cross-sectional diagram of a server 500 provided by another embodiment of the present invention along a longitudinal direction B5 (shown by FIG. 5).

Referring to FIGS. 5 and 6A, the bridge board 530 has two golden fingers 531 and 532. In addition, a plurality of connection lines, for example, connection lines 541-543 shown in FIG. 6A, is disposed on the bridge board 530 and electrically connected to the golden fingers 531 and 532. In terms of the overall layout, the mother board 210 and the back board 220 are perpendicular to a direction in a side surface of the bridge board 530, and the golden fingers 531 and 532 are disposed on the above-mentioned side surface of the bridge board 530.

Referring to FIGS. 6A and 6B, although the two embodiments shown by FIGS. 6A and 6B are the same that the mother board 210 is perpendicular to a direction in a side surface of the bridge board 530 and the golden finger 531 is disposed on the side surface of the bridge board 530, but there is a significant difference between the two embodiments. Different from the embodiment of FIG. 6A, in the embodiment of FIG. 6B, the back board 220 is perpendicular to another direction in another side surface of the bridge board 530, and the golden finger 532 is accordingly disposed on the other side surface of the bridge board 530.

Note that, similar to the first embodiment, the second embodiment is able to use the connection lines disposed on the bridge board 530 to deliver signals to the front board and the back board; while the conventional server 100 (as shown in FIG. 1) would conduct the same job by employing a large number of transmission lines. In this way, the server 500 of the second embodiment can reduce obstructing the heat-dissipating mechanism of a system caused by the transmission lines and thereby promote the stability of the internal system.

### The Third Embodiment

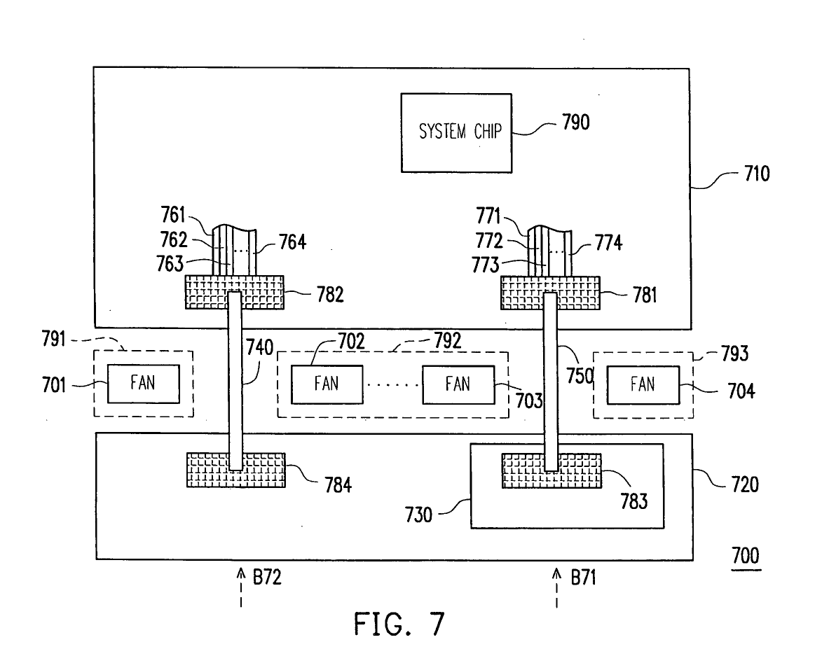

FIG. 7 is a system architecture diagram of a server according to the third embodiment of the present invention. Referring to FIG. 7, a server 700 includes a mother board 710, a back board 720, a front board 730 and two bridge boards 740 and 750, wherein a plurality of connection lines 7611-764 and 771-774, two slots 781 and 782 and a system chip 790 are disposed on the mother board 710. The connection lines 761-764 are electrically connected to the slot 782 and the connection lines 771-774 are electrically connected to the slot 781. In addition, another two slots 783 and 784 are respectively disposed on the front board 730 and the back board 720.

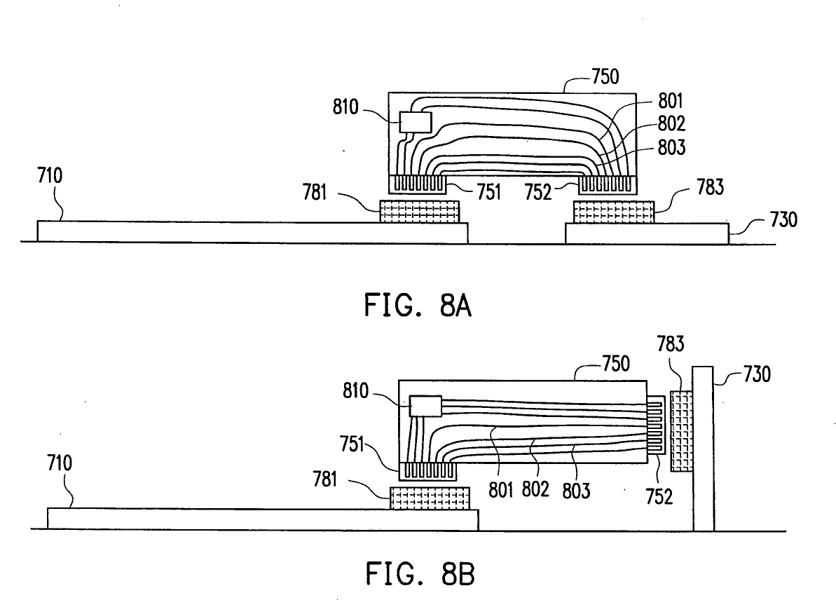

FIG. 8A is a cross-section diagram of a server 700 provided by an embodiment of the present invention along a longitudinal direction B5 (shown by FIG. 7). Referring to FIGS. 7 and 8A, the bridge board 750 has two golden fingers 751 and 752. In addition, a plurality of connection lines, for example, connection lines 801-803 shown in FIG. 8A, is disposed on the bridge board 750 and electrically connected to the golden fingers 751 and 752. In terms of the overall architecture, the golden fingers 751 and 752 can be respectively inserted into the slots 781 and 783.

The connection lines 771-774 herein are used to deliver a plurality of power signals and a plurality of first control signals conforming to a specific data transfer interface specification. The slots 781 and 783 are respectively electrically connected to the golden finger 751 and 752 located on the bridge boards 750. Thus, the first control signals and the power signals from the mother board 710 are delivered to the front board 730 through the connection lines on the bridge boards 750. Note that the system chip 790 can generate a part of the first control signals delivered by the connection lines 771-774, and the specific data transfer interface with the specification the first control signals conform is a USB interface.

Continuing to FIG. 8A, the server 700 further includes a power control circuit 810, which is disposed on the bridge boards 750 for controlling the power signals from the mother board 710. Compared to the prior art, since the power control circuit originally disposed on the mother board is re-disposed on the bridge boards 750 in the present embodiment, therefore, the mother board 710 of the embodiment has superiority in miniaturization.

In terms of overall layout, the front board 730 and the mother board 710 are perpendicular to a direction in a side surface of the bridge board 750 and the golden fingers 751 and 752 are disposed on the side surface of the bridge board 750, but anyone skilled in the art can alter the relative positions of the front board 730, the mother board 710 and the bridge boards 750 referring to the longitudinal cross-section diagram of FIG. 8B.

Referring to FIGS. 8A and 8B, although the two embodiments shown by FIGS. 8A and 8B are the same that the mother board 710 is perpendicular a direction in to a side surface of the bridge board 750, and the golden finger 751 is disposed on the side surface of the bridge board 750, but there is a significant difference between the two embodiments. Different from the embodiment of FIG. 8A, in the embodiment of FIG. 8B, the front board 730 is perpendicular to another direction in another side surface of the bridge board 750 and the golden finger 752 is accordingly disposed on the other side surface of the bridge board 750.

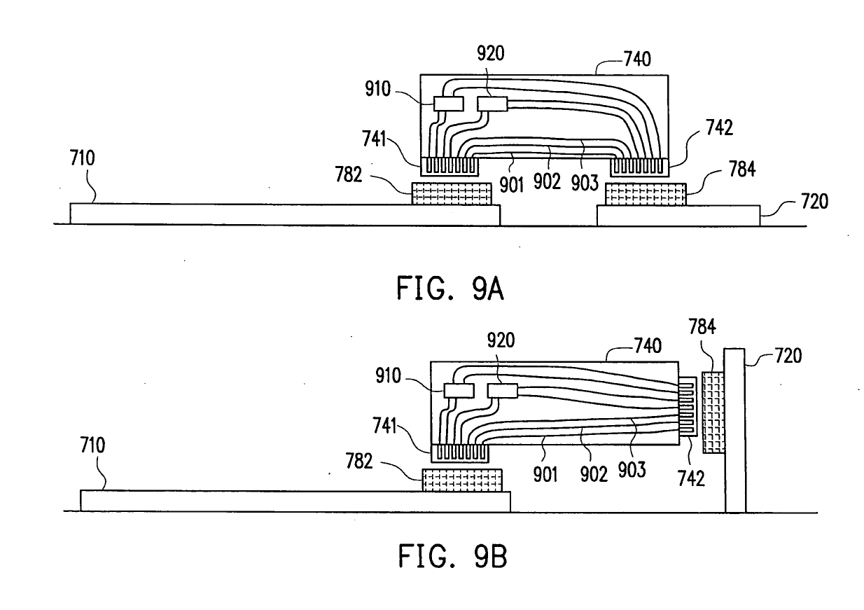

FIG. 9A is a cross-section diagram of a server 700 provided by an embodiment of the present invention along a longitudinal direction B5 (shown by FIG. 7). Referring to FIGS. 7 and 9A, the bridge board 740 further has two golden fingers 741 and 742. In addition, a plurality of connection lines, for example, connection lines 901-903 shown in FIG. 9A, is disposed on the bridge board 740 and electrically connected to the golden fingers 741 and 742. In terms of the overall architecture, the golden fingers 741 and 2742 can be respectively inserted into the slots 782 and 782.

In terms of the overall operations, the connection lines 761-764 herein are used to deliver a plurality of second control signals conforming to the specifications of a plurality of data transfer interfaces. For example, the slots 782 and 784 are respectively electrically connected to the golden finger 741 and 742 located on the bridge boards 740. Thus, the second control signals from the mother board 710 are delivered to the back board 720 through the connection lines on the bridge boards 740.

Note that the system chip 790 is also used to generate a part of the second control signals delivered by the connection lines 761-764. In addition, the data transfer interfaces with the specifications the second control signals conform include a USB interface (universal serial bus interface), a SATA interface, a floppy disk drive interface and an IDE interface; the said slots 781-784 can be implemented by using slots conforming to the specification of PCI-X interface or PCI-E interface.

For example, when the back board 720 and the front board 730 adopt parallel data-transferring mode, anyone skilled in the art can directly employs a slot conforming the PCI-X interface specification; in contrast, when the back board 720 and the front board 730 adopt serial data-transferring mode, a slot conforming the PCI-E interface specification is directly used. Furthermore, a serial-to-parallel converter or a parallel-to-serial converter can be respectively disposed on the mother board 710, the back board 720 and the front board 730 to optionally use the slot conforming the PCI-X interface specification or the slot conforming the PCI-E interface specification.

Continuing to refer to FIG. 9A, the server 700 further includes a plurality of interface control circuits, for example, the interface control circuits 910 and 920 shown in FIG. 9A. The interface control circuits herein are disposed on the bridge boards 740 for controlling the second control signals from the mother board 710. Compared to the prior art, since the power control circuit originally disposed on the mother board is re-disposed on the bridge boards 740 in the present embodiment, therefore, the mother board 710 of the embodiment has superiority in miniaturization.

In terms of overall layout, the back board 720 and the mother board 710 are perpendicular to a direction in a side surface of the bridge board 740 and the golden fingers 741 and 742 are disposed on the side surface of the bridge board 740, but anyone skilled in the art can alter the relative positions of the back board 720, the mother board 710 and the bridge boards 750 referring to the longitudinal cross-section diagram of FIG. 9B.

Referring to FIGS. 9A and 9B, although the two embodiments shown by FIGS. 8A and 8B are the same that the mother board 710 is perpendicular to a direction in a side surface of the bridge board 740 and the golden finger 741 is disposed on the side surface of the bridge board 740, but there is a significant difference between the two embodiments. Different from the embodiment of FIG. 9A, in the embodiment of FIG. 9B, the back board 720 is perpendicular to another direction in another side surface of the bridge board 740, and the golden finger 742 is accordingly disposed on the other side surface of the bridge board 740.

Referring to FIG. 7, the server further includes fans 701-704 and frames 791-793, wherein the frames 791-793 are parallel to the mother board 710. The fans 701-704 are respectively disposed on the frames 791-793 for producing an airflow so as to reduce the waste heat of the server 700. Note that the connection lines disposed on the bridge boards 740 and 750 are respectively electrically connected to the front board 730 and the back board 720 in the embodiment, therefore, the server 500 of the invention can reduce obstructing the heat-dissipating mechanism of a system caused by the transmission lines.

In summary, since the present invention uses the connection lines on the bridge board to substitute the transmission lines between the mother board and the front board or the back board. In this way, the server provided by the present invention is able to reduce obstructing the heat-dissipating mechanism of the system caused by the transmission lines and thereby to promote the stability of the internal system. Moreover, the hardware space of the server appears better with neat and nice look due to fewer transmission lines are disposed.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A server, comprising:
a mother board, having a plurality of first connection lines and a first slot disposed thereon, wherein the first connection lines are electrically connected to the first slot for delivering a plurality of power signals and a plurality of control signals, and the control signals respectively conform the specification of one of a plurality of data transfer interfaces;
a back board, having a second slot disposed thereon; and
a bridge board, having a first golden finger, a second golden finger and a plurality of second connection lines disposed on the bridge board, wherein the second connection lines are electrically connected to the first golden finger and the second golden finger, the first golden finger and the second golden finger are respectively inserted into the first slot and the second slot so that the control signals and the power signals are delivered to the back board through the second connection lines.

2. The server according to claim 1, wherein the data transfer interfaces comprise a USB interface, a SATA interface, a floppy disk drive interface and an integrated drive electronics interface.

3. The server according to claim 1, further comprising:
a system chip, disposed on the mother board for generating a part of the control signals.

4. The server according to claim 1, further comprising:
a plurality of expansion slots, disposed on the mother board for accepting a plurality of expansion cards inserted into the expansion slots, wherein the expansion cards for generating a part of the control signals.

5. The server according to claim 4, wherein the expansion cards comprise a SATA expansion card, a SCSI expansion card and a serial attached SCSI expansion card.

6. The server according to claim 4, wherein the expansion slots conform to the specification of PCI interface or PCI-E interface.

7. The server according to claim 1, wherein the mother board is parallel to a direction in a side surface of the bridge board, and the first golden finger is disposed on the side surface of the bridge board.

8. The server according to claim 7, wherein the back board is parallel to another direction in another side surface of the bridge board, and the second golden finger is disposed on the other side surface of the bridge board.

9. The server according to claim 7, wherein the back board is perpendicular to another direction in another side surface of the bridge board, and the second golden finger is disposed on the other side surface of the bridge board.

10. The server according to claim 7, further comprising:
a frame, parallel to the bridge board, wherein the lower surface of the frame is across the bridge board; and
a plurality of fans, disposed on the upper surface of the frame for producing an airflow to reduce the waste heat of the server.

11. The server according to claim 1, wherein the mother board is perpendicular to a direction in a side surface of the bridge board, and the first golden finger is disposed on the side surface of the bridge board.

12. The server according to claim 11, wherein the back board is perpendicular to another direction in another side surface of the bridge board, and the second golden finger is disposed on the other side surface of the bridge board.

13. The server according to claim 11, wherein the back board is perpendicular to the direction in the side surface of the bridge board, and the second golden finger is disposed on the side surface of the bridge board.

14. The server according to claim 11, further comprising:
at least a frame, parallel to the mother board; and
a plurality of fans, disposed on the frames.

15. The server according to claim 1, wherein the first slot and the second slot conform to the specification of PCI-X interface or PCI-E interface.

16. A server, comprising:
a front board, having a first slot disposed thereon;
a back board, having a second slot disposed thereon;
a mother board, having a plurality of first connection lines, a plurality of second connection lines, a third slot and a fourth slot disposed on the mother board, wherein the first connection lines are electrically connected to the third slot for delivering a plurality of power signals and a plurality of first control signals, and the first control signals conform to the specification of a specific data transfer interface; the second connection lines are electrically connected to the fourth slot for delivering a plurality of second control signals, and the second control signals conform to the specifications of a plurality of data transfer interfaces;
a first bridge board, having a first golden finger, a second golden finger and a plurality of third connection lines disposed on the first bridge board, wherein the third connection lines are electrically connected to the first golden finger and the second golden finger, the first golden finger and the second golden finger are respectively inserted into the first slot and the third slot so that the first control signals and the power signals are delivered to the front board through the third connection lines; and
a second bridge board, having a third golden finger, a fourth golden finger and a plurality of fourth connection lines disposed on the second bridge board, wherein the fourth connection lines are electrically connected to the third golden finger and the fourth golden finger, the third golden finger and the fourth golden finger are respectively inserted into the second slot and the fourth slot so that the second control signals are delivered to the back board through the fourth connection lines.

17. The server according to claim 16, wherein the specific data transfer interface comprises a universal serial bus interface, and the data transfer interfaces comprise a SATA interface, a floppy disk drive interface and an integrated drive electronics interface.

18. The server according to claim 16, further comprising:
a system chip, disposed on the mother board for generating the first control signals and a part of the second control signals.

19. The server according to claim 16, wherein the front board and the mother board are perpendicular to a direction in a side surface of the first bridge board, and the first golden finger and the second golden finger are disposed on the side surface of the first bridge board.

20. The server according to claim 16, wherein the back board and the mother board are perpendicular to a direction in a side surface of the second bridge board, and the third golden finger and the fourth golden finger are disposed on the side surface of the second bridge board.

21. The server according to claim 16, wherein the front board is perpendicular to a direction in a side surface of the first bridge board, the mother board is perpendicular to another direction in another side surface of the first bridge board, and the first golden finger and the second golden finger are respectively disposed on the side surface of the first bridge board and the other side surface of the first bridge board.

22. The server according to claim 16, wherein the back board is perpendicular to a direction in a side surface of the second bridge board, the mother board is perpendicular to another direction in another side surface of the second bridge board, and the third golden finger and the fourth golden finger are respectively disposed on the side surface of the second bridge board and the other side surface of the second bridge board.

23. The server according to claim 16, further comprising:
at least a frame, parallel to the mother board; and
a plurality of fans, disposed on the frame for producing an airflow to reduce the waste heat of the server.

24. The server according to claim 16, further comprising:
a power control circuit, disposed on the first bridge board for controlling the control signals from the mother board; and
a plurality of interface control circuits, disposed on the second bridge board for controlling the second control signals from the mother board.

25. The server according to claim 16, wherein the first slot, the second slot, the third slot and the fourth slot conform to PCI-X interface specification or PCI-E interface specification.
